(19) United States
(12) Patent Application Publication
(10) Pub. No.: US 2026/0174064 A1
(43) Pub. Date: Jun. 25, 2026

(54) Green Light Therapy Dog Enclosure

(71) Applicant: Elena Kohn, Scottsdale, AZ (US)

(72) Inventor: Elena Kohn, Scottsdale, AZ (US)

(21) Appl. No.: 19/428,104

(22) Filed: Dec. 20, 2025

Related U.S. Application Data
(60) Provisional application No. 63/737,532, filed on Dec. 20, 2024.
(60) Provisional application No. 63/844,586, filed on Jul. 15, 2025.

(51) Int. Cl. A01K 29/00; A61D 99/00

(52) U.S. Cl. CPC A01K 29/004; A61D 99/00

(57) ABSTRACT

A green light therapy dog enclosure is provided. Such enclosures generally include enclosing sides, a base, a top, and internally mounted or integrated LED lights capable of emitting light in the desired green light wavelength. The enclosure further includes a power source (preferably rechargeable) and a control unit (manual or wireless).

### CROSS REFERENCE TO RELATED APPLICATIONS

This application is a non-provisional that claims priority from a provisional U.S. patent application No. 63/737,532 filed on Dec. 20, 2024 and 63/844,586 filed on Jul. 15, 2025.

### FIELD OF THE INVENTION

Embodiments of the invention generally relate to dog products, but can relate to pets in general (including cats), and wellness products. Specifically, embodiments of the invention relate to pet enclosures that incorporate therapeutic green light technology.

### BACKGROUND OF THE INVENTION

Dogs are among the most popular domesticated pet in the United States. Dog owners often spend a significant amount of time with their dogs and a significant amount of money purchasing products for their dogs. This includes products for improving their pets' health, behavior, well-being and overall quality of life.

The color green in the 510 to 560 nanometer range creates an atmosphere of serenity and calmness, drawing from its reflection in the natural world. Light therapy has existed for a long time and is increasingly being used in both human and veterinary settings. More specifically, green light therapy in this nanometer range has been shown to reduce stress and anxiety and improve pain relief and healing. Other benefits of green light therapy range from skin treatment to easing pain and even fighting depression. It is a non-invasive, low heat, eye-friendly wavelength that aligns with circadian biology.

Dog enclosures are structures designed to safely contain dogs, offering various levels of confinement and comfort. They can includes crates and pens for temporary indoor use and kennels and dog houses for outdoor spaces. Some enclosures have varying levels of mobility such as travel carriers. These enclosures serve different purposes, including providing a safe space for dogs aiding in training, and preventing them from wandering off.

### BRIEF DESCRIPTION OF THE DRAWINGS

The accompanying drawings taken in conjunction with the detailed description will assist in making the advantages and aspects of the disclosure more apparent.

FIG. 1 is an above exploded perspective view of an embodiment of a green light therapy pet enclosure inspired by a dog carrier.

FIG. 2 is a below perspective view of an embodiment of a green light therapy pet enclosure inspired by a dog carrier with the green light active and pet inside.

FIG. 3 is an above perspective view of an alternative embodiment of a green light therapy pet enclosure inspired by a castle style dog house.

FIG. 4 is a below perspective view of an alternative embodiment of a green light therapy pet enclosure inspired by a dog house with the green light active.

### SUMMARY

A green light therapy dog enclosure is provided. Such enclosures generally include enclosing sides, a base, a top, and internally mounted or integrated LED lights capable of emitting light in the desired green light wavelength. The enclosure further includes a power source (preferably rechargeable) and a control unit (manual or wireless).

The disclosed green light therapy dog enclosures are designed to provide a therapeutic benefit and help promote relaxation for the dog. Green light can be particularly helpful for stress or anxiety relief, having a calming effect on the nervous system. Green light can help with behavioral modulation, particularly for shelter dogs, high energy or reactive breeds, or pets undergoing training or socialization therapy. Green light may according to new research at the time of this disclosure help with pain relief, having potential application in dogs with arthritis or joint pain, post-surgical recovery and chronic musculoskeletal discomfort.

Dog enclosures are structures designed to safely contain dogs, offering various levels of confinement and comfort, which is further enhanced by the addition of green light therapy.

### DETAILED DESCRIPTION

Reference will now be made in detail to the present embodiments discussed herein, illustrated in the accompanying drawings. The embodiments are described below to explain the disclosed invention by referring to the Figures using like numerals. It will nevertheless be understood that no limitation of the scope is thereby intended, such alterations and further modifications in the illustrated invention, and such further applications of the principles as illustrated therein being contemplated as would normally occur to one skilled in the art to which the embodiments relate.

The disclosed green light therapy dog enclosures are designed to provide a therapeutic benefit. The green light is emitted by the LEDs having a wavelength 510 to 560 nanometers, 525 nanometers in the preferred embodiment, and helps promote relaxation for the dog. Green light can be particularly helpful for stress or anxiety relief, having a calming effect on the nervous system. This may help reduce the symptoms of separation anxiety, noise phobia and generalized nervousness or restlessness, and as such is used in veterinary clinics to soothe anxious pets before exams or procedures. Green light can improve sleep cycles, by regulating circadian rhythms and may help dogs fall asleep more easily and sleep more deeply. Green light can help with behavioral modulation, particularly for shelter dogs, high energy or reactive breeds, or pets undergoing training or socialization therapy. Green light may according to new research at the time of this disclosure help with pain relief, having potential application in dogs with arthritis or joint pain, post-surgical recovery and chronic musculoskeletal discomfort. Green light has added benefit of being gentler on the eyes and produces little to no heat. Uses of the disclosed enclosure include calming pets during travel or rest, recovery environments post-vet visit or surgery, routine anxiety management for dogs with behavioral disorders, training centers for hyper-reactive or shelter dogs.

A green light therapy dog enclosure is provided. For the purpose of this disclosure, enclosures can mean kennels, crates, carriers, houses, castles, igloos, dog runs, pens, and no limitation is intended. Embodiments of the enclosure generally include enclosing sides, a base, a top, and internally mounted or integrated LED lights capable of emitting light in the desired green light wavelength. The enclosure further includes a power source (preferably rechargeable) and a control unit (manual or wireless).

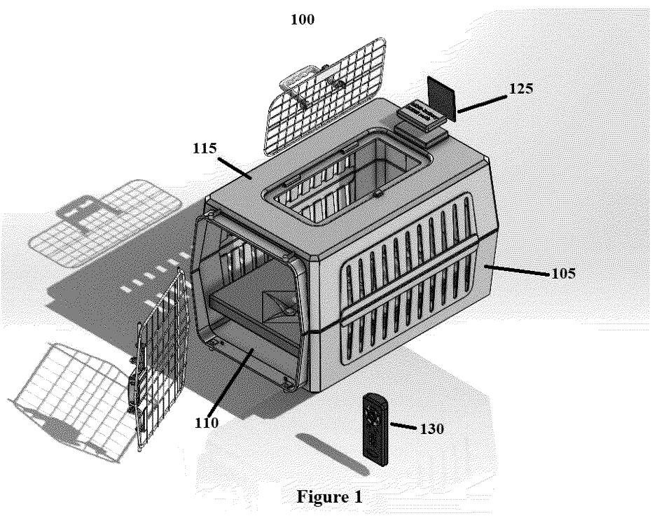

As illustrated in FIG. 1, a green light therapy dog enclosure 100, inspired by travel carriers for dogs, enhanced with green light therapy wellness technology is provided. The disclosed invention provides both a secure and soothing atmosphere where dogs can enjoy relaxation with stress relief, and a way for owners to transport their animals in this environment. The disclosed design merges scientific wellness technologies with canine comfort, ensuring dogs can experience the benefits of green light therapy in a stress-free environment.

As illustrated, the green light therapy dog enclosure has dimensions similar to a standard dog carrier and can be configured for small, medium and large dogs. In the preferred embodiment, the enclosure is made of lightweight, durable plastic similar to other carriers on the market. Such material is used for the walls (side panels) 105, a bottom or base 110 (though base can be more than just a bottom panel) and top 115 of the enclosure resulting in an easy-to-assemble frame. The depicted design of the enclosure is semi-open to prevent claustrophobia, while still offering privacy and comfort. Other features include anti-slip silicone feet to ensure stability on all surfaces, and a foldable or modular design for easy storage and transport.

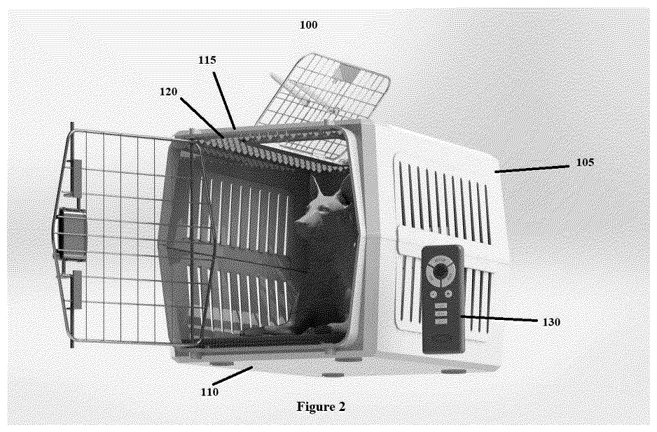

As show in FIG. 2, in preferred embodiments, LED lights 120 specifically designed to emit green light 525 nanometer wavelengths for therapy, which can be LED light bulbs or LED light strips, are mounted on an interior ceiling top panel of the enclosure, along the ceiling perimeter. Other embodiments may have LED lights on perimeter side panels (walls). The green light is dispersed gently, creating a calming environment inside the enclosure without overwhelming the pet. In the preferred embodiment, the LED green lights are housed in Plastic Mounting Tracks specifically designed for LED Strips located in the roof panel to keep the LED lights inaccessible to the pet. Such a roof panel is detachable for maintenance and ease of access. In other embodiments, the LED lights are integrated directly into the panels.

In the preferred embodiment, a rechargeable power system is included with the disclosed invention. This includes a rechargeable Lithium-Ion Battery Pack, housed in the base in the preferred embodiment, for wireless operation and portability that powers the LEDs providing lasting illumination. Further, the battery is designed to be rechargeable through a discreet, weatherproof USB-C port. Also contained in the roof panel are an LED Driver Circuit 125 that delivers power to the green LEDs, ensuring consistent brightness and longevity and a Power Management Unit that ensures the system is energy-efficient, allowing the green light to shine for several hours on a single charge.

The green light therapy dog enclosure is equipped with a touch or button control on the roof panel or a side panel allowing users to turn the green light on or off easily. When turned on, the green LEDs illuminate the inside of the enclosure, providing calming green light therapy. Other embodiments may utilize a wireless remote 130 or phone app that allow the enclosure to function without being plugged in, providing mobility and convenience. The remote control can further allow users to adjust brightness settings or set a timer for therapy cycles.

Other embodiments may include secondary LED lights that can be configured for white light for case or visibility. Such secondary LED lights may be controlled by additional buttons on the light control or remote, allowing the user more control over the light provided to the dog.

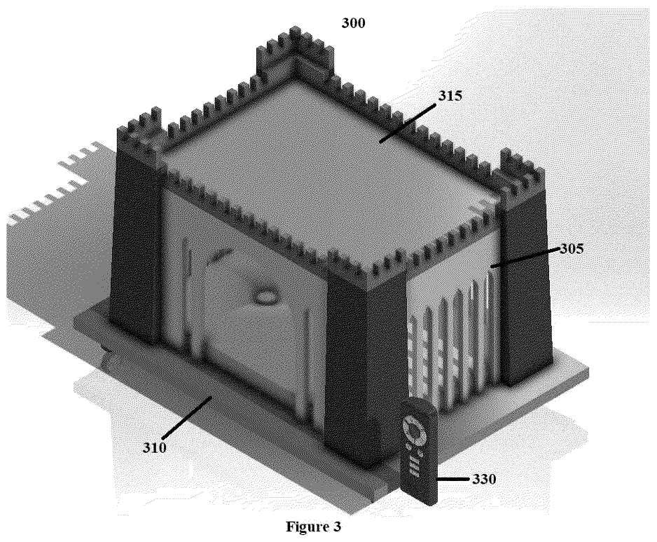

As illustrated in FIG. 3, an alternative green light therapy dog enclosure 300, inspired by a dog house, in the shape of a castle and enhanced with green light therapy wellness technology is provided. The disclosed invention provides both a secure and soothing atmosphere where dogs can enjoy relaxation with stress relief. The disclosed design merges scientific wellness technologies with canine comfort, ensuring dogs can experience the benefits of green light therapy in a stress-free environment.

As illustrated, the green light therapy dog enclosure has dimensions similar to a standard dog house and can be configured for small, medium and large dogs. The depicted design is intended to blend into home or garden environments. In the preferred embodiment, the enclosure is made of thick, durable plastic similar to other dog houses on the market, however other materials may be contemplated such as weather resistant wood. Such material is used for the walls 305, base 310, and top 315 of the enclosure. In the preferred embodiment, the design of the enclosure is semi-open to prevent claustrophobia, while still offering privacy and comfort, though solid walls may be contemplated. Wheels 325 may be affixed to the bottom of the enclosure for ease of mobility.

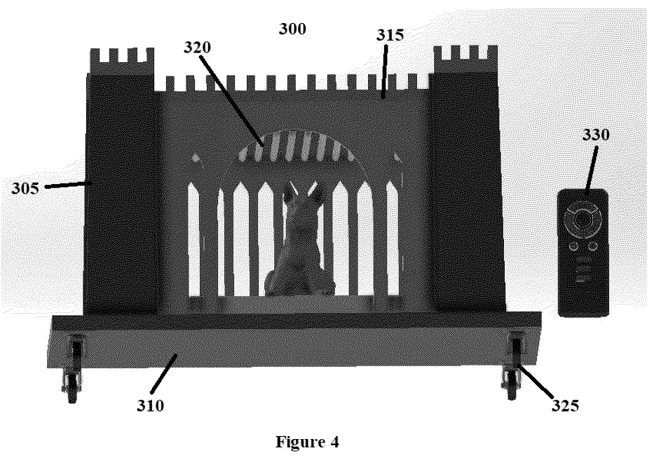

As show in FIG. 4, in the preferred embodiments, LED lights 320 specifically designed to emit green light 525 nanometer wavelengths for therapy, which can be LED light bulbs or LED light strips, are mounted on the interior ceiling of the enclosure, along the ceiling perimeter. Other embodiments may have LED lights on the perimeter side walls. The green light is dispersed gently, creating a calming environment inside the enclosure without overwhelming the pet. In the preferred embodiment, the LED green lights are housed in Plastic Mounting Tracks specifically designed for LED Strips located in the ceilingfor case or visibility to keep the LED lights inaccessible to the pet. In other embodiments, the LED lights are integrated directly into the top or walls.

In the preferred embodiment, a rechargeable power system is included with the disclosed invention. This includes a rechargeable Lithium-Ion Battery Pack, housed in the base in the preferred embodiment, for wireless operation and portability that powers the LEDs providing lasting illumination. Further, the battery is designed to be rechargeable through a discreet, weatherproof USB-C port. Also contained in the roof panel are an LED Driver Circuit that delivers power to the green LEDs, ensuring consistent brightness and longevity and the Power Management Unit that ensures the system is energy-efficient, allowing the green light to shine for several hours on a single charge.

The green light therapy dog enclosure is equipped with a touch or button control on the roof panel or a side panel allowing users to turn the green light on or off easily. When turned on, the green LEDs illuminate the inside of the enclosure, providing calming green light therapy. Other embodiments may utilize a wireless remote 330 or phone app that allow the enclosure to function without being plugged in, providing mobility and convenience. The remote control can further allow users to adjust brightness settings or set a timer for therapy cycles.

Other embodiments may include secondary LED lights that can be configured for white light for improved visibility. Such secondary LED lights may be controlled by additional buttons on the light control or remote, allowing the user more control over the light provided to the dog. The white light and green light can be configured in a variety of ways to work alternatively or in coordination with each other.

The preceding description contains embodiments of the invention and no limitation of the scope is thereby intended. It will be further apparent to those skilled in the art that various modifications and variations can be made in the present invention without departing from the spirit or scope of the invention.

1. A green light dog enclosure comprising:
enclosing sides, a base, a top, and internally mounted or integrated LED lights capable of emitting light in the desired green light wavelength.

2. The green light dog enclosure of claim 1 further comprising:
a power source.

3. The green light dog enclosure of claim 1 further comprising:
a control unit.
